(19) United States
(12) Patent Application Publication
(10) Pub. No.: US 2025/0196392 A1
(43) Pub. Date: Jun. 19, 2025

(54) Post-Sawing Quality Control, Inspection and Packaging of Shingles in Computer-Assisted Wood Shingle Manufacturing

(71) Applicant: Clair Industrial Development Corporation Ltd., Clair (CA)

(72) Inventor: Pierre Michaud, Clair (CA)

(73) Assignee: Clair Industrial Development Corporation Ltd., Clair (CA)

(21) Appl. No.: 18/542,630

(22) Filed: Dec. 16, 2023

(51) Int. Cl. B27B 31/06; B27M 3/02; E04D 1/20

(52) U.S. Cl. CPC B27B 31/06; B27M 3/02; E04D 1/205

(57) ABSTRACT

In a first aspect, there is provided a system for picking sawed shingles against a saw in movement. Further, F in a method for maintaining a database of images of shingle defects, wherein a front-face image and a backside image of a shingle are associated with each other in that database. To increase shingle quality, each shingle is inspected on five faces thereof, to detect surface defects and core defects. Comparison is made of images of the front-face to images of wood defects in the database. When the image of the front-face of a shingle matches an image of an acceptable defect, and that front-face image is tagged as “predisposed to backside defect”, the shingle is edged to remove the acceptable defect. In the shingle manufacturing process, each of these backside images is considered to be a mirror image of a next shingle to be sawed.

### FIELD OF THE PRESENT INVENTION

The present invention pertains to the field of shingle manufacturing, and more particularly it pertains to shingle handling, inspection, database recording, quality control and packaging in a computer-assisted wood shingle manufacturing operation.

### BACKGROUND OF THE PRESENT INVENTION

The computer-assisted shingle sawing installation or machine referenced herein is described in U.S. Pat. No. 10,968,648, and in U.S. patent application Ser. No. 17/803,842, the content of both documents are incorporated herein by reference. The “computer-assisted shingle sawing installation or machine” mentioned above is referred to herein after as the “new shingle machine”, for convenience. Portions of this patent and application are incorporated herein to ensure the completeness of the present specification.

The shingle sawing profession is perhaps the most demanding one in the field of forest industries. Besides the danger and monotony of the manual sawing of shingles, a larger challenge is in the classification of shingles. A clever and skilled sawyer needs a long apprenticeship to do classification of shingles. Such combination is difficult to incorporate into a computer to do classification by machine vision. The grade selection standard for wood shingle requires visual acuity, a subjective interpretation of dozens of quality criteria, and a keen decision-making ability that is difficult to match by a computer. It will be appreciated that the grade-selection standards for wood shingles have not been written for interpretation by a computer.

Shingle classification is done in Canada according to the well-known CSA Standard entitled: CAN/CSA 0118.2-94 (0118.2M-94) Eastern White Cedar Shingles. Similar classification standards are known in the USA and are published by CSSB; Cedar Shake and Shingle Bureau, IBC; International Building Code, and IRC; International Residential Code. Shingle grades in the CSA code are simplified as follows:
“EXTRA-Grade A”: has a clear face below and above the clear line;
“CLEAR, Grade B”: tolerates defects above the clear line;
“SECOND CLEAR, Grade C”: tolerates sound knots below the clear line;
“CLEAR WHITE”: tolerates pin knots under the clear line;
“UTILITY: all natural wood defects are permitted as long as 50% of the surface is solid wood;
“CULL”: all that cannot be classified in any other classifications.

Grades “A” and “B” are traditionally used for outside wall and roof coverings, where grade “A” is installed with a larger exposed surface than grade “B”.

Grade “C”, “Second Clear”, and grade “Clear White” shingles are all purposes shingles used on inside walls and decorative partitions, for examples.

Grade “Utility” shingles are used for shimming windows and doors and for levelling floor beams of mobile homes, and other similar shimming uses.

Grade “CULL” shingles are those that contain too many defects or that are too narrow to be used as shim stock.

During classification of a shingle, there are approximately twenty (20) different types of defects to be considered, with variations in each type. Classification is selected from five (5) different shingle grades. It becomes a tremendous task to train a sawyer or to program a computer to consider all the permutations of these 20 types and 5 grades.

It will be appreciated that a major portion of these criteria are determined subjectively. These criteria are not related to 1 and 0 defect determinations, as it is done by a computer. A good shingle sawyer normally does an apprenticeship as a bundle maker for one thousand hours or more to develop skills in learning shingle quality criteria. After this first apprenticeship, the young sawyer works under a close supervision of a senior sawyer for another thousand hours or more. Only then, an apprentice can become an accomplished shingle sawyer.

For all these reasons, basically, past attempts to manufacture wood shingle using robotic machinery and machine vision have enjoyed a limited success. There remains, more than ever, a need in the industry to address computer-assisted shingle sawing and machine vision.

U.S. Pat. No. 8,113,098 issued to J. L. Longfellow on Feb. 14, 2012. This document describes a machine vision system to determine optimal saw cut to maximize the value of shingles. Wood slabs are exposed to a camera, and a computer determines where the defects are. The shingle is then processed through an edger to trim it to remove any undesired defect.

The “new shingle machine” referenced in U.S. Pat. No. 10,968,648, issued to the present inventor on Apr. 6, 2021, has had better success at classifying shingles using machine vision.

During the early testing of the “new shingle machine”, classification of shingles remained a subject for improvement. In particular, there are many defects picked up by machine vision that are not actual defects. Some of these “false defects” include natural colourations such as heart wood for example, and flying objects such as splinters, slivers, wood shavings and sawdust passing in front of the camera, or dust particles adhering to the lens of the camera.

Therefore, it is believed that there is a need in the shingle industry for a machine vision system that can differentiate between real defects and false defects. There is also a need in the shingle manufacturing industry for a machine vision system that is sufficiently reliable to obviate the need for shingle sawyers to memorize the booklet describing the CSA Standard entitled: CAN/CSA 0118.2-94 (0118.2M-94) Eastern White Cedar Shingles.

### SUMMARY OF THE PRESENT INVENTION

In the present invention, there is provided a post-sawing quality control, inspection of shingles in computer-assisted wood shingle manufacturing. There is also provided a shingle packaging installation for producing shingles packages of a highest quality.

In a first aspect of the present post-sawing quality control and inspection, there is provided a system for picking sawed shingles against a saw in movement. That system comprises a shingle sawing machine having a carriage, a saw mounted along the carriage, and an electronic group comprising a computer; a machine vision system connected to the computer, an image tracking system for tracking an image taken by the machine vision system, and a carriage tracking system for tracking a movement of a wood block on the carriage toward and away from the saw. The shingle sawing machine is partly controlled by this electronic group. A shingle picker is mounted at a proximity of the saw, on a common structure with the saw. The shingle picker is controlled by the electronic group, and it is configured to grab a shingle against the saw in movement before the shingle is sawed off a wood block by the saw.

In another aspect of the present post-sawing quality control and inspection, the system also comprises a camera mounted at proximity of the saw, and the shingle picker is configured for rotating each shingle from a plane of the saw to an orientation where a latter-sawed or backside of the shingle is visible to the camera.

In yet another aspect of the present post-sawing quality control and inspection, there is provided a method for maintaining a database of images of shingle defects. This method comprises the steps of taking a front-face image and a backside image of every shingle and associating the backside image to the front-face image in the database, and entering these images chronologically in the database.

The method described above further comprises the step of comparing the backside image with the front-face image, and tagging the front-face image as “predisposed to backside defect” when the backside image contain an unacceptable defect.

During the manufacturing of shingles, the second front-face image of a pair of adjacent front-face images, as well as these backside images are assumed to be previews or mirror-images respectively, of the front-face image of the next shingle to be sawn. These previews and mirror images can be used to trigger a skip-a-scan or double-cut mode. Using pairs of front-face and backside images, it is possible to assume or predict the quality of a third consecutive cut to be made in a multi-cut mode.

In a further aspect of the present post-sawing quality control and inspection, there is also provided a method of manufacturing quality shingle packages comprising the steps of;
squaring each shingles before that shingle is sawed off from a wood block;
inspecting each shingle in a package for defect on a front-face, a backside, a butt face and both edge faces thereof;
comparing the front-face images and backside images to images of wood defect in a database of images of wood defects;
when the front-face image matches an image of an acceptable defect and the front-face image is tagged as “predisposed to backside defect”, edging that shingle to remove the acceptable defect.

This summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the classification, sawing and post-sawing quality control, inspection and packaging of shingles using machine vision, according to the present invention is described with the aid of the accompanying drawings, in which like numerals denote like parts throughout the several views:

FIG. 1 is a representation of a Grade A shingle;

FIG. 2 is a representation of a Grade B shingle;

FIGS. 3 and 3A are representations of a same shingle being classified as Grade C in FIG. 3 or as Grade B in its mirror image of FIG. 3A;

FIG. 4 is a representation of a Grade D shingle;

FIG. 5 is an elevation view of a cedar block as seen by the camera of the machine vision system;

FIG. 6 is a side view of the wood block shown in FIG. 5;

FIG. 7 illustrates a flow diagram of a first algorithm subroutine used for classification by machine vision using the clear-below-the-line approach;

FIG. 8 illustrates a flow diagram of a second algorithm subroutine for increasing shingle thickness on high grade shingles;

FIG. 9 shows the proper placement of partial views of FIGS. 9A and 9B;

FIGS. 9A and 9B is a process flow diagram of a main algorithm used in the new shingle machine;

FIG. 10 is a top view of a wood block showing typical branch roots in that block;

FIG. 11 illustrates another top view of a wood block showing shingle width variations near the centre of the block;

FIG. 12 is a plan view of the “new shingle machine” in which a machine vision system has been developed;

FIG. 13 is a perspective view of a conventional shingle sawing installation showing a second potential application of the machine vision system;

FIG. 14 is an enlarged view of the display screen shown in circle 14 in FIG. 13;

FIG. 15 is a perspective view of a manual shingle edging installation, showing a third potential use of the machine vision system;

FIG. 16 is a perspective view of a robotic shingle packaging installation, showing a fourth potential use of the machine vision system;

FIG. 17 is another perspective view of a robotic installation using the machine vision system;

FIGS. 18 and 19 explain the picking of shingles against a saw in movement and the releasing of shingles from the robotic hand onto a transfer conveyor;

FIG. 20 is a partial cross-section view of the releasing of shingles onto a transfer conveyor as seen along line 20 in FIG. 19;

FIG. 21 illustrate front-face and backside images of a same shingle;

FIG. 22 is a schematic of the subroutine no. 3 in the main algorithm;

FIG. 23 illustrate a floor plan of the inspection and packaging area of the preferred shingle sawing and packaging installation;

FIG. 24 is a partial perspective view of a shingle-accumulating magazine used in the packaging of shingles;

FIG. 25 is an enlarged partial portion of the shingle packaging installation, as seen in circle 25 in FIG. 23;

### DETAILED DESCRIPTION OF THE PREFERRED EMBODIMENT

The preferred embodiment of the shingle post-sawing quality control, inspection, and packaging installation according to the present invention is described herein below with reference to the attached drawings. The drawings presented herein are schematic in nature and should not be scaled.

Many components of the preferred installation were not illustrated to facilitate the understanding of the basic concept of the design and method of the preferred machine vision system. The components that were not illustrated are those for which the nature, mountings and functions would be obvious to the person skilled in the art of machine vision, forestry equipment and machine design.

The installation according to the preferred embodiment for carrying the method of the present invention is also described in term of its operation and the function of its components. The physical dimensions, material types, and manufacturing tolerances of the system are not provided because these details also do not constitute the essence of the present invention and would be considered obvious to the skilled artisan having acquired the knowledge that is actually provided herein.

For reference purposes, FIG. 1 is a Grade A shingle, clear of any visual defect. Grade A shingles have the greatest market value. A minimum width is 3 inches. The market value increases in proportion to its width.

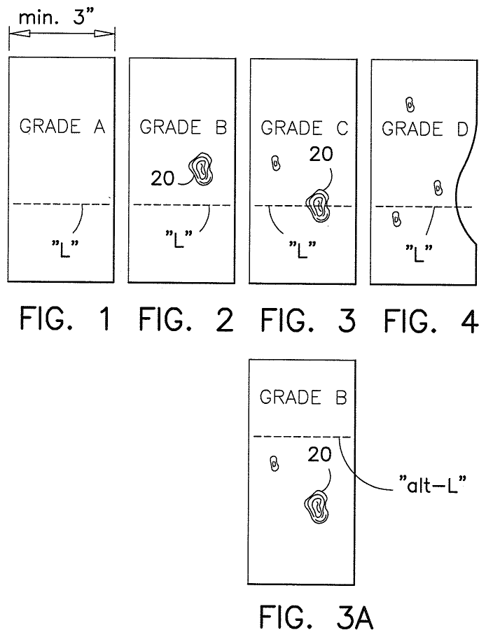

A Grade B shingle, as in FIG. 2, tolerates a defect above the exposed portion thereof. As can be noted, the defect 20 is located above the line of exposure “L” or the clear line of the shingle, usually 6 inches (15.2 mm) from the butt.

A Grade C shingle as shown in FIG. 3 has one defect extending below the line of exposure “L”.

### Optimization-by-Inversion

One important aspect of the method according the present invention is that before cutting the shingle shown in FIG. 3, the spur rolls of the “new shingle machine” may adjusted the angle of the cut on the block so that butt of the shingle and the exposed portion of the shingle is on top of the slab, such as shown in FIG. 3A. By doing so, a Grade C shingle becomes a Grade B shingle, with a much greater market value. This method is referred to herein as “optimization by inversion”.

A Grade D shingle, as illustrated in FIG. 4, has too many defects therein, to be used as a shingle product and therefore, it is usually trimmed as window/door shim stock.

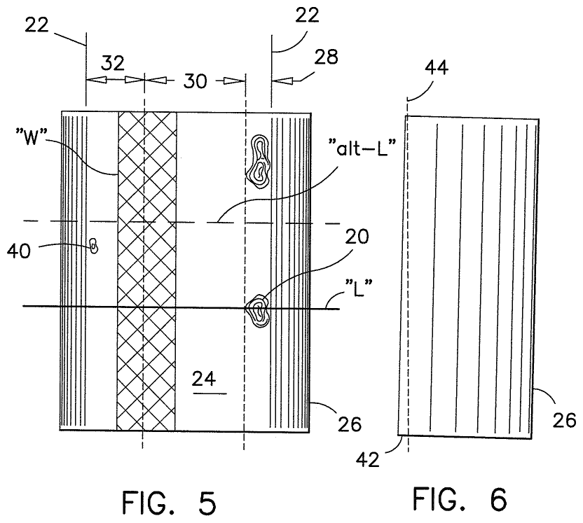

Referring now to FIG. 5, both outside lines 22 represent the outside edges (landings or edging lines) of the slab 24 to be cut during the next pass into the main saw of the “new shingle machine”.

In the preferred method, the main computer has been programmed to look at the image of the slab 24, the front-face image, and to make 0 or 1 determination of defect(s) in relation of a one-line-one-window algorithm, while ignoring all the criteria of the quality standard referred to before in Grade A and Grade B. The algorithm uses two variables:
1) the visible portion or line of exposure “L” (or clear line) of the shingles to be taken from the block, and
2) a 3-inch wide-full-length window “W” moving across the slab 24.

The computer analyses the images using the machine vision system and scans the face of the slab, inside the window ‘W’, for the slightest defect. If a defect is found, irregardless of their size or gravity, they are identified as a positive digit.

When the sweeping window “W” finds a 3-inch-wide strip with no defect along the full length thereof, this strip is identified as a minimum-width Grade A shingle.

When the sweeping window “W” finds a 3-inch strip with one or more defects above the clear line and no defect below the clear line “L”, that strip is identified as a minimum-width Grade B shingle.

When the sweeping window “W” finds a defect below the clear line “L”, a trim line is assigned to each side of the defect, and that strip between the trim lines is identified as a cull strip.

During the sweeping of the window “W” across the face of the slab 24, the total available width of each of GRADE A shingle and GRADE B shingle and the location(s) of cull strips are recorded.

The width of both identified shingle grades is sequentially increased by the computer from the data obtained by the sweeping window “W”. The width increase is done according to market value of each grade, to obtain optimum recovery value from each slab 24.

The above analysis is repeated with an alternative clear line “alt-L”, and a decision is made according to a better recovery between the first and second analysis whether the butt end of the next slab 24 is on the top or bottom of the block 26.

Once a determination of shingle Grade and width is done, the cedar block 26 is presented to the trimming saw (not shown) and moved back and forth along rails (not shown) so that trimming can be done along the edging lines 22, to define the widths of one or more shingles in that slab 24.

Using the above analysis, the slab 24 shown in FIG. 5 was separated as strip 28 classified as a cull strip, for containing one defect 20 in the visible portion of the shingle, and another one in the covered portion. The remaining portion of the slab 24 was separated into a 5 inches wide Grade A-EXTRA shingle 30 for containing 0 defect over its entire surface; and a 3-inch-wide Grade B-CLEAR shingle 32, containing one small defect 40 above the clear line “L” of the shingle.

Referring back to FIG. 6, the wood block 26 is indexed on spur rolls (not shown) of the “new shingle machine”. In the “new shingle machine” referenced herein, the wood block 26 can be indexed up to eight consecutive times with the butt end 42 of the shingle in the same end of the block 26. The computer system of the “new shingle machine” has the ability to recognize cases of optimization by inversion as illustrated using FIGS. 3 and 3A, and decides on the characteristics of the inclination of the parting line 44 and the location of the butt end 42 of the next shingles, to obtain a best recovery.

This preferred 0-1 defect-one-line-one-window algorithm was introduced to human sawyers. These sawyers were asked to test the method. Cedar blocks were selected randomly, sawed and trimmed according to this preferred simplified method. After careful tabulation of the resulting products, it was found that the yield of Grade A and Grade B shingles from these blocks had increased by 20%, and the resultant quality of packaged shingles in both grades had also increased by 20% as compared to conventional sawing using the conventional quality criteria. The income obtained from these test blocks also increased accordingly. These tests indicate that it is possible to replace the subjectivity of a human sawyer, by 0-1 defect determinations of a computer to manufacture and classify high quality wood shingles.

On the other hand, it is an enormous computer task to analyse the location of a defect relative to the clear line; analyse the size of a defect relative to the shingle width; the type and condition of defect, i.e. a healthy or loose knot, a resin pocket above the 6 inches or 8 inches clear line, etc. During the testing of a machine vision system on the “new shingle machine”, it has been found that the removal of defects in cull strips was being effected more often than necessary, resulting in waste.

### Eliminating Remediable Defects

Because computers work better with “0” and “1” and “true” or “false” pixel analysis, a classification of shingles by machine vision needs to be formulated accordingly. Defects that are related to “black” and “white” are easy detectable by machine vision, whereas hues and shades are not easily seen. Therefore, in the present classification by machine vision, the following steps have been taken initially.

### Mechanical Defects

Mechanical defects that can be corrected include: non-parallel edges; length; thickness, width, torn grain and waves. These defects have been eliminated on the “new shingle machine” by using a well-maintained shingle sawing machine with true-running, well-maintained and sharpened saws, and where the size and thickness of each shingle is determined by precise instrumentation.

Therefore, defects related to mechanics mentioned above are no longer an issue with machine vision. Mechanical defects are ignored in a classification by machine vision.

### Grain Orientation

Relative to grain orientation, blocks that have been sawed along a plane that is not at least quasi-perpendicular to the axis of the tree from which it came, have not been accepted. This has eliminated grain orientation defects in the finish product. Grain orientation is ignored in a classification by machine vision.

### Sapwood

Relative to sapwood, an improved camera system has been successfully used to recognize sapwood. Sapwood defects are now recognized as such in a classification by machine vision.

### Overall Wood Quality

Relative to overall wood quality, the “new shingle machine” accepts cedar blocks that have 11 inches or more of diameter on the small end of the block. This has improved shingle quality. These blocks generally are coming from the base of mature trees, where branches are scarce. Knot defects are thereby eliminated to a considerable extent.

### Black and White Defects

The remaining defects comprise: knots, decay, checks, cracks, wane, holes, bark and resin pockets. All of these defects are easily detectable by machine vision for being visible as black marks on a light background. In other words, these defects are considered “black” and “white” defects. These defects also have another common attribute that they are not acceptable below the clear line in Grade “A” or Grade “B” shingles.

### Shingle Thicknesses

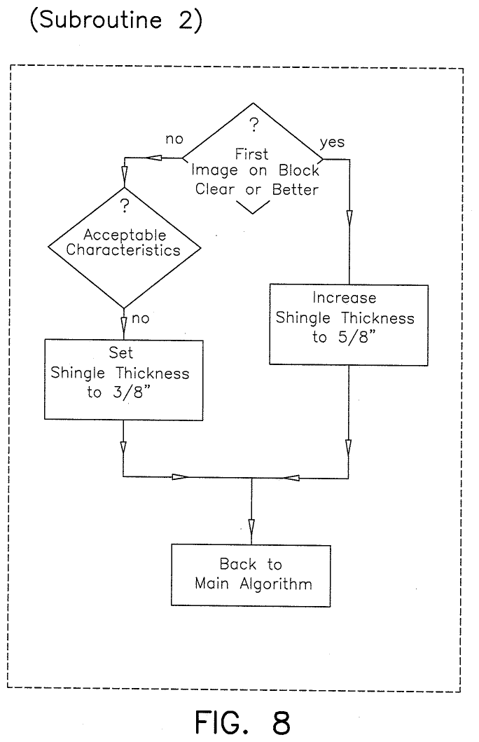

Thicker shingles sell for a higher price than thinner shingles. Thicker shingles produce less waste in sawdust than the thinner version, by generating fewer saw cuts. Therefore, there is an advantage of producing thicker shingle as often as possible to increase recovery and profitability. For this purpose, Subroutine 2 illustrated in FIG. 8 has been prepared and incorporated into the main algorithm.

When a first image on a new cedar block shows a Grade A or B shingle, the probability is that this block contains few defects. The thickness of the first and subsequent shingles in that block is set to ⅝″. The quality of every shingle is still monitored. As soon as a Grade C or Grade D shingle is found, the thickness of that inferior quality shingle is reduced to ⅜″.

### Clear-Below-the-Clear-Line

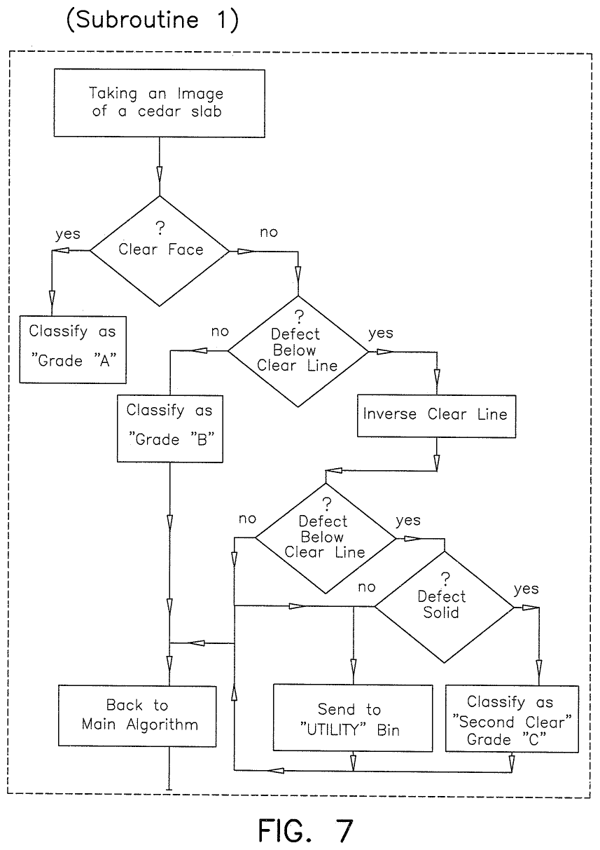

Referring back to FIG. 7, the machine vision system is based on a “clear-below-the-clear-line” approach. The machine vision system is asked a “0” or “1” question for a “0” or “1” answer. The question is: “is there at least one defect below the clear line?” In a first iteration, a “no” answer yields a “A or B” grade, and a “yes” answer yields a call for inversion. In a second iteration a “no” answer yields a “B” grade and a “yes” answer calls for a determination of a solid knot to sort out between a Grade C “Second Clear” shingle or a Grade “Rework”.

This “clear-below-the-clear-line” approach has resulted in the reduction of significant waste of raw material. This approach has resulted in an almost complete elimination of the removal cull strips from shingles. Although the step of removing of a cull strip at the “Rework” station to recover a Grade A, B or C shingle remains an option, this practice has been reduced significantly from the clear-below-the-clear-line and optimization-by-inversion approaches mentioned herein.

As a result of the method described above, shingle recovery has improved to the point of doubling the revenue from the raw material used, relative to the traditional shingle sawing.

### Defects Discrimination Algorithm (the Main Algorithm)

Although great improvement has been done and described above, it is believed that reliable classification of shingles by machine vision is only possible with a machine vision system that can make abstraction of “false defects”.

A scanning process has been developed to address false defects such as natural colourations and flying objects. This analytic process uses two artificial intelligence neural networks, for increasing the accuracy of defect detection; for eliminating false defects; for building a robust database of images of confirmed defects, and for skipping the scanning step as often as possible.

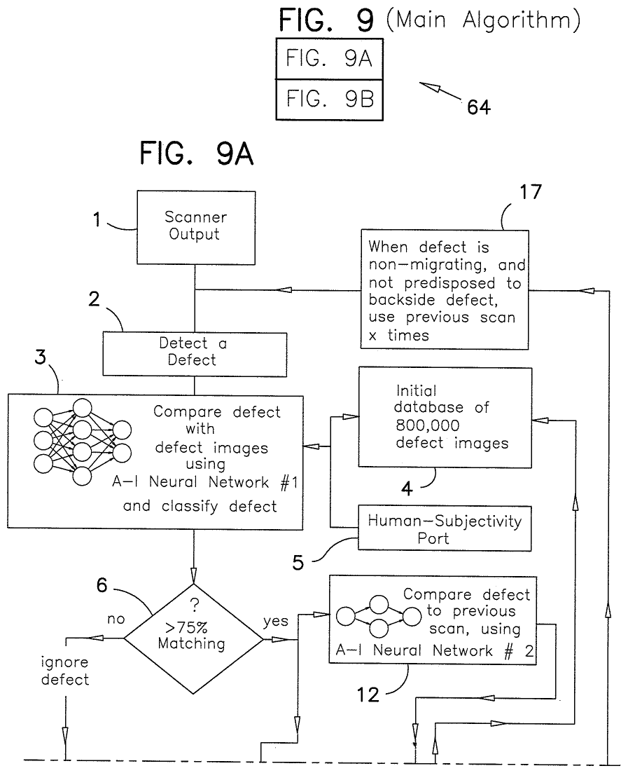

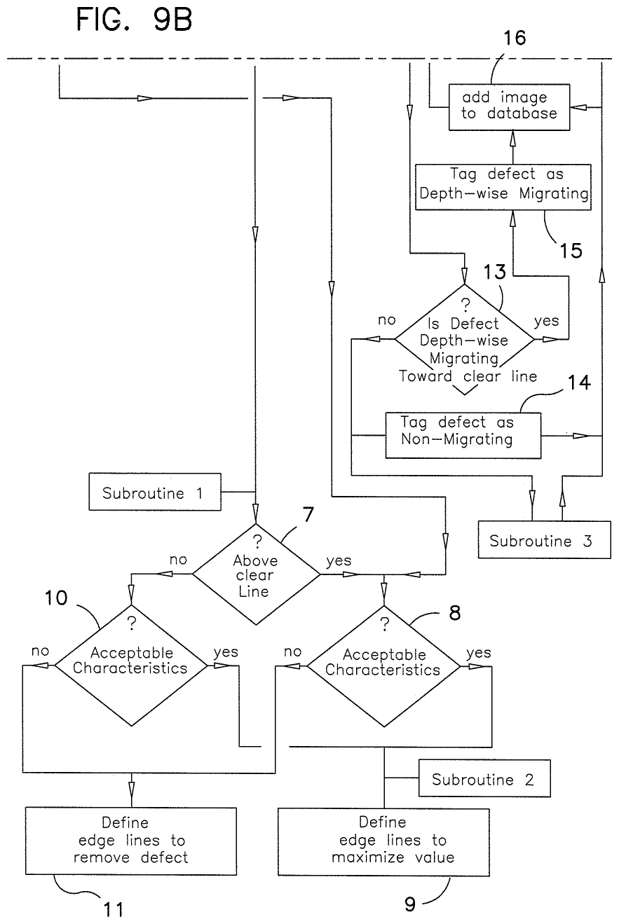

This defect discrimination algorithm 64 is illustrated in FIGS. 9A and 9B, and described as follows:
Step 1: Reference is firstly made to label 1 in FIG. 9A. A scanner is used to obtain an image of a slab in a cedar block prior to sawing one or more shingles out of this slab in one pass into the large saw. The scanner output uses modern cameras to provide a digitized image that can be analysed by pixels and by colour of each pixel. It is known that modern browsers supporting the full spectrum of 24-bit colours offer up to 16,777,216 different colour possibilities. Such technologies are used in the present scanner output.
(Note 1): The expression ‘next cut’ or ‘next saw cut’ used herein refers to one pass into the main larger saw of the “new shingle machine”.
Step 2: The image is analysed to detect a defect. Defects are detected as contrasts in colour. A tolerance variable is introduced in that step to allow for shades and tints of natural wood.
Steps 3 and 4: when a defect is detected, that defect is classified accordingly, as a knot, a blob of resin, a crack, a patch of sapwood, for examples. The defect is compared to similar confirmed defects in a database of images of confirmed defects. Initially, the database contains 800,000 images of confirmed defects. The confirmed defects in the database have been entered partly manually and partly automatically from the confirmed defects found during past operation of the “new shingle machine”. The analysis is done by comparing pixels of an image of a defect to pixels of images in the database and finding an array of matching pixels on the image of the defect and on at least one of the images in the database, wherein the array contains a percentage of matching pixels in the image. A percentage of 75% is used herein as an example.
(Note 2): The diagrams of circles and arrows in Steps 3 and 12, represent symbols for neural networks in an Artificial Intelligence System.

### Human Subjectivity Port

One of the additional layers to the present flow chart in FIG. 9, as mentioned before, is related to Step 3 and 4. The additional layer is referred to herein as a human subjectivity port. This port consists in a display screen (not shown); a keyboard (not shown); algorithm system, software and a computer port allowing connection of this layer to the main algorithm 64. This human subjectivity port allows a human manipulation of the images of confirmed defect in the database. This human-subjectivity port is referenced as Step 5 in the main algorithm 64. The images of confirmed defects in the database are filed chronologically or by traceable batches for example. It is possible to manually scroll through the images in the database, and manually change the tag or the classification of any images, or to remove or to add images, whenever an inconsistency is found during the final manual inspection of shingles, during packaging for example.

The management of the database by personnel at an inspection or packaging station, introduces human logic and subjectivity in the database. As mentioned before, the initial database of images of confirmed defects contained an inventory of 800,000 images. Most of these images were verified, confirmed, and entered by experienced shingle sawyers. New images are managed by an artificial intelligence network, based on similarity with the initial inventory, as shown in Steps 3 and 4 of the main algorithm 64. It will be appreciated that the artificial intelligence system has been trained and is continually training on images that contain the subjectivity of experienced shingle sawyers. The new layer mentioned above, in Step 5, provides a further degree of confirmation of new images added to the database, by experienced shingle sawyers. For these reasons, it is believed that the decision-making ability of the preferred algorithm 64 has a high degree of equivalence to the skills of a human shingle sawyer. It is believed that the decision-making ability of the main algorithm 64 is done using a combination of human subjectivity and artificial intelligence.

Furthermore, as will be better explained later, AI is trained to compare the front-face and backside pairs stored in the database with pairs of adjacent images in that database, and tag additional “predisposed to backside defect” images from these adjacent images. This additional step increases the precision with which defects are detected by the main algorithm.

Because of the artificial intelligence network, and the human-subjectivity approach, the precision of the algorithm 64 of defect discrimination improves continually, by a process that is well known in the field of artificial intelligence.
Step 6: In association with Steps 3 and 4 of comparing a defect with the image database, this step provides a variable, shown now as 75%, to adjust the precision with which defects are classified as real defects or false defects.

Although 75% is shown, any other number can be used. In this example, when 75% of the pixels in an array of a scanned image match a similar array on an image in the database of confirmed defects, the scanned defect is treated as a real defect. A matching scanned image is eventually added to the database of confirmed defects.

If a scan does not match a confirmed defect to the precision requested, this scanned defect is treated as a false defect, and the image is considered to be a clear shingle. False defects are not added to the database.

Examples of false defects is a colour spot or distinctive mark due to a hammer blow, or similar shock for example, done to a young or juvenile tree, and which mark remained embedded in the age-rings of the tree. Other examples of false defects are natural colourations, and flying objects as mentioned before.
Step 7: When a real defect is found, the query process proceeds to examine whether or not this defect is above or below the clear line on the shingle to be sawed.
Step 8: When the defect is above the clear line, the query process verifies whether or not the defect is an acceptable one for one classification or another.
Step 9: When all the grade characteristics are found to be allowable, the edge lines of the shingles to be sawed from the slab of the next cut are defined to maximize the value of these shingles.
Step 10: When a defect is found below the clear line in Step 7, the scan is examined to determined if the defect consists of an acceptable characteristic. Again, the edge lines are defined to maximize the value of that lower grade.
Step 11: If a defect is not acceptable for a Clear or Better or utility, the edge lines of the shingles to be sawed from the slab of the next cut are defined to remove the defect.

### Migrating Defects

Step 12: As mentioned above, when a scanned defect matches an image of a confirmed defect to a precision of 75% or better, for example, that scanned image is added to the database of images of confirmed defects. However, before doing so, another analysis is effected. This next analysis is to determined whether the defect found extends depth-wise in a perpendicular direction relative to the surface of the wood slab in the present scan, or migrates obliquely up or down or to one side or the other. For example, a knot may be found to be clear above the clear line on the front face of a shingle, but may migrate below the clear line on the shingle underneath.

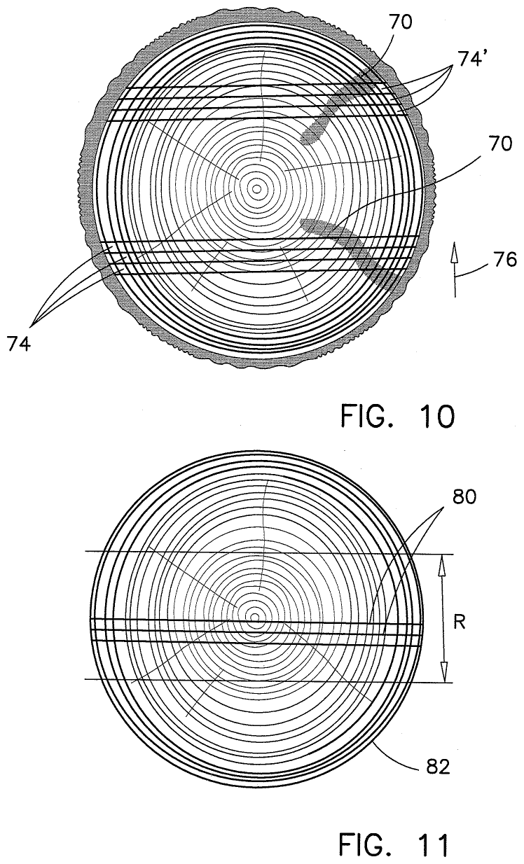

Referring now to FIG. 10, the radial discolorations 70 on the wood block 72 in this drawing represent roots of branches. When shingles 74 are sawed in the direction of arrow 76 for example, this defect migrates inwardly from one shingle to the next on shingles 74 taken on the near side of the block. This type of defect migrates outwardly from one shingle to the next on shingles 74′ taken on the far side of the block.

This depth-wise analysis is effected by an algorithm combined with a second neural network such as to continually increase prediction accuracy. This depth-wise analysis is effected by comparing the present scan to the previous scan and analysing the relative positions of all the defects found on both scanned images. This analysis determines the direction of migration of the defects that are common to both scans.
Step 13: Once the direction of migration is defined in the above step, a determination is made to find whether one or more defects migrates toward the clear line or the edge lines on the shingles to be sawed on the next saw cut.
Step 14: When the defect found extends perpendicular to the surface of the scanned slab, this or these defects are tagged as “non-migrating”.
Step 15: When at least one of the defects found do migrate depth-wise toward the clear line or the edge lines, this or these defects are tagged as “depth-wise migrating”.
Step 16: Whether a defect is migrating or not, these defects are added to the database of confirmed defects with their respective tags.
Step 17: When all the defects found on a scan are not migrating; in other words, when all the defects found are extending perpendicular to the surface of the slab, the next scan is assumed to be very similar to the present scan being studied.

Therefore, there is no need to scan the wood block 26 again for the next saw cut. Because there is a very strong possibility that the next scan will be a same image as the one just studied, there is an advantage of using a scan several times, and saving production time by eliminating re-scan time. It is estimated that scanning wood blocks at every second saw cut for example, can increase production output by 45%.

### Double-Cut Mode

Reference is now made to FIG. 11, to describe another method to increase production output. It will be appreciated from this diagram that the widths of slabs 80 taken in the central region “R” of a wood block 82 are almost identical, and the shingles taken from these have identical commercial value. Therefore, when a “skip-a-scan” slab has been found, a comparison of the width of that slab with the previous one is used to determine whether these slabs are taken from a central region “R” of a block. If the width of one slab approximates the width of an adjacent slab, a “double-cut mode” is initiated. In a “double-cut mode”, the edging lines of the next shingle are cut deeper, to a thickness of two shingles. The carriage is move toward the main saw to cut the top shingle(s); the block is moved backward just enough to clear the main saw, and forward again to cut the bottom shingle(s). This double cut is effected without moving the slab to the scanning or to the edging stations. This shorter block displacement represents the saving in production time. A soon as the width of two superimposed slabs exceed a defined value, (one-half inch for example) the sawing returns to a single pass mode.

In a double-cut mode, however, a portion of 12-13% of shingles are sent to “rework”, as opposed to only 8% in a single-cut mode. This increase in “rework” is over-shadowed by the 45% increase in production given by a double-cut mode.

In a double-cut mode, a comparison is first made between the width of a first and second contiguous slabs, and then the comparison is made between the second and fourth adjacent slabs, and fourth and sixth adjacent slabs, and so on. Although a double-cut mode has been thoroughly tested and is now a proven advantageous feature, it is possible by using pairs of associated front-face and backside images, to assume or predict the quality of a third consecutive cut to be made in a multi-cut mode. This multi-cut mode is being tested during the preparation of this document.

### Single-Pass Edging Mode

In a double-cut mode, the edging of both superimposed shingle(s) is effected in a single-pass edging mode, as mentioned above. This single pass edging is effected by edging a slab at a depth of two shingles, with the tip of the edging saw protruding precisely in the kerf of the next cut to be made by the main saw. The edging is effected without scribing or otherwise marking the surface of the next slab exposed by the kerf. This single-pass edging is effected with a same precision, whether the machine is using an optimization-by-inversion mode; two thick ends on top or bottom, alternated thick end position, or with varying thickness shingles.

As mentioned herein before, one or more layers can be added to this flow chart of FIG. 9. In another example of an additional layer, using the “human subjectivity port”, any employee doing visual inspection of the finished product, can go back into the database of images when an error is found, and scroll back to verify the classification of a defect associated with a finish product. That person can also manually remove a false defect from the database.

In relations to layers, the subroutine 1 can be attached to the main algorithm in a separate layer and executed in parallel, in series or in other association with step 7 in the main algorithm, and subroutine 2 can be attached and executed in a same way with step 9, as suggested in FIG. 9B.

Additionally, another layer to this flow chart will integrate the system according to the present invention to an additional system being designed for packaging shingles using robotics and machine vision, such as illustrated in FIGS. 16-25, for examples. The addition of that new layer will ensure that the grade selection and width of shingles produced using the system according to the present invention are memorized and shared between production and packaging, and a final inspection at packaging can be used to validate, modify, add or subtract from the database in step 4.

### Elements of the Machine Vision System

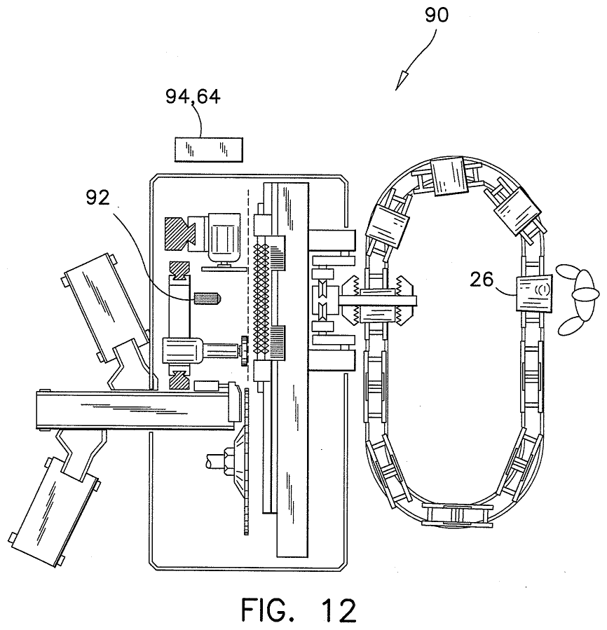

It is believed that the machine vision system according to the preferred embodiment of the present invention can now be used reliably on many applications related to shingle manufacturing. Referring firstly to the “new shingle machine” 90 shown in FIG. 12, the preferred machine vision system comprises a camera 92, a computer 94 storing and working a database of images of confirmed defects and a defect discrimination algorithm 64, incorporated in the computer.

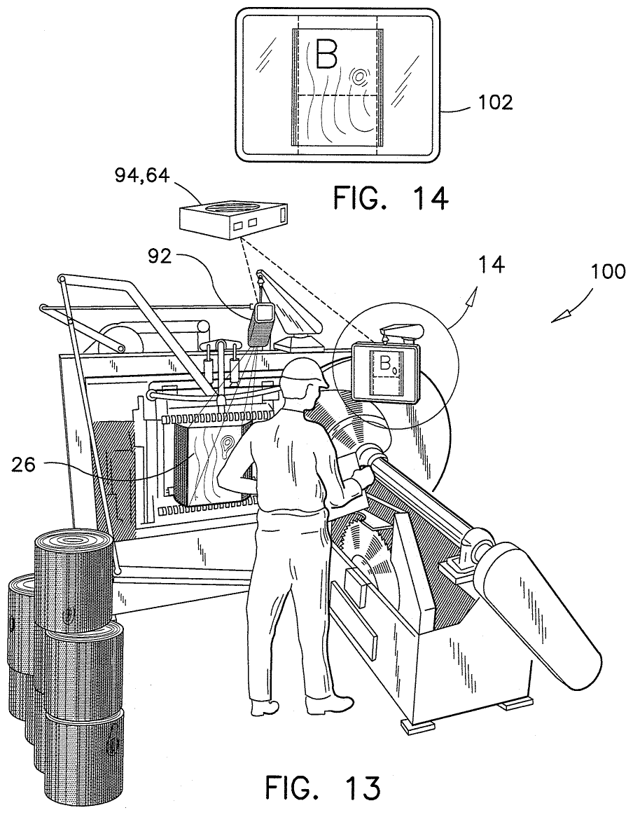

It is believed that the preferred machine vision system 92, 94, 64 can also be used on a conventional shingle sawing machine 100 as shown in FIG. 13, to instruct the sawyer on a display screen 102, in FIG. 14, of the suggested grade and edging lines of the shingle just sawed.

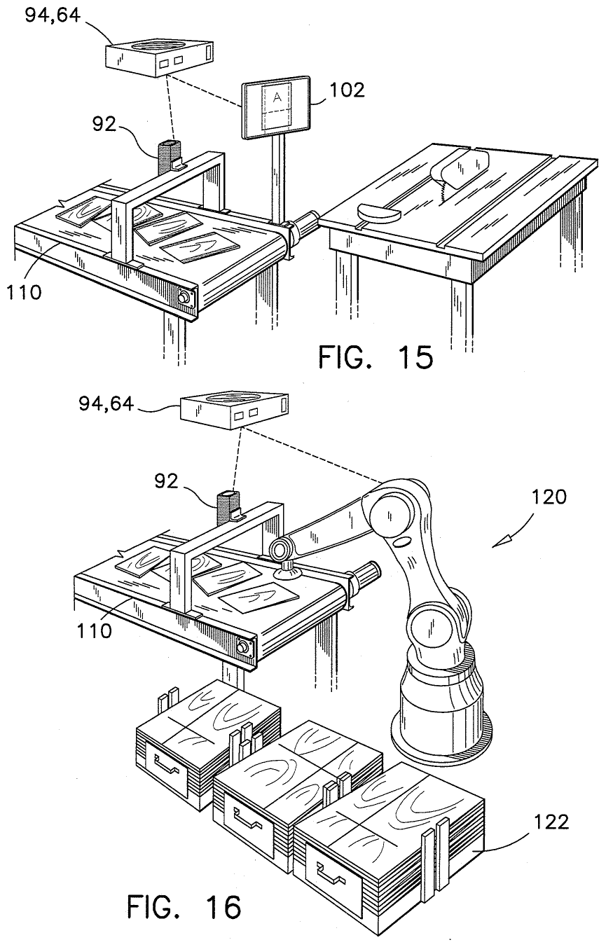

When the edging of shingles is done on a separate work station, the machine vision system 92, 94, 64 can also be installed on a conveyor 110, as shown in FIG. 15 and instruct a table-saw operator on a display screen 102 of the suggested edging lines and grade of the next shingle coming on the conveyor 110.

Similarly, the preferred machine vision system 92, 94, 64 can also be used to control a robotic shingle packaging machine 120 to pick shingles from a conveyor 110 and to place these shingles in appropriate classification boxes 122 for packaging, as illustrated in FIG. 16.

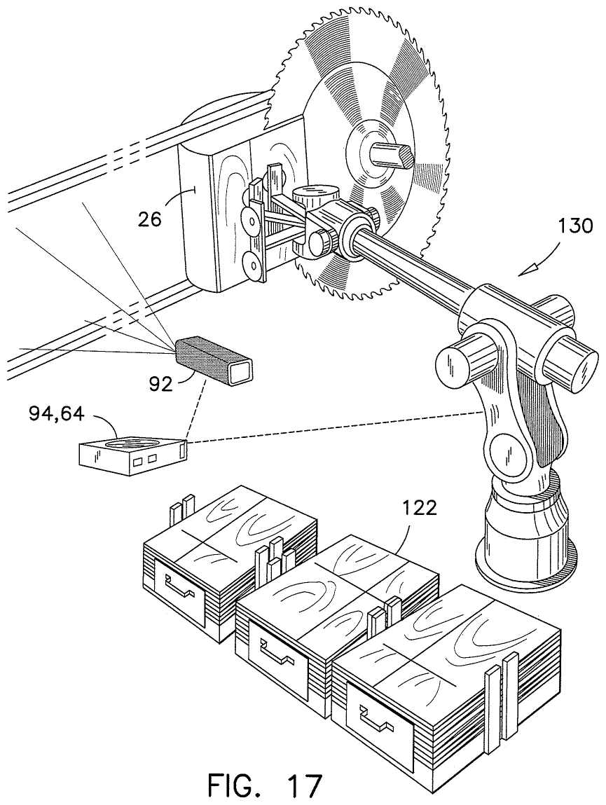

Furthermore, the preferred machine vision system 92, 94, 64 can also be used to control a robotic shingle picking and manipulating machine 130 to pick shingles against the main saw while being cut and to place these shingles in classification boxes 122 as schematically illustrated in FIG. 17.

In summary, the method for classification of shingles by machine vision comprises the following steps:
Eliminating machine defects and cedar block imperfections;
Analysing a surface of a wood block using a “One-Line-One-Window” approach;
Considering “Black and White” defects only;
Using a “clear-below-the-line” approach to classification;
Using an “Optimization-by-Inversion” approach to classification;
Using a “Skip-a-Scan” approach to scanning;
Using an “Adjust-Shingle-Thickness” approach to maximize value;
Using a “Skip-a-Scan” event to revert to a “Double-Cut mode”;
Using a precise Single-Pass Edging mode to allow a Double-Cut mode;
Building a robust database of images of confirmed defects;
Using a human subjectivity approach to database management;
Making abstraction of any defect not matching a confirmed defect,
Comparing pairs of adjacent front-face images and pairs of associated backside and front-face images to generate a preview of the quality of a next shingle, and
Using Artificial Intelligence for continuing improvement of database management and defect discrimination.

The classification of shingle by machine vision according to the preferred embodiment has been used with great success. It also has been found that because of continuous improvement, some of the requirements mentioned above can be relaxed by a substantial extent. For example, the word “eliminating” relative to remediable defects, can be changed to “reducing” while the preferred classification by machine vision still performs with acceptable commercial results. Also, the initial black and white defects approach can be upgraded to coloured defects, and more than four grades can be considered.

Referring to FIG. 18 and beyond, the installation for inspection and packaging of shingles will be explained. Shingles 140 are picked up against the main saw 142 while being sawed from a wood block 26, by a gripper 144 on a first robotic manipulator 146. The preferred robotic manipulator 146 and its gripper 144, have capabilities to pick up and manipulate up to four shingles per handful batch. This is convenient for picking up two shingles from a first cut and two shingles from a second cut, when operating in a double-cut mode. When a double cut contains more than four shingles, the carriage automatically slows down for the second cut to release a fifth or sixth shingle, for example, only after the picker has returned to the saw with an empty hand.

The first robotic manipulator 146 is also configured to rotate the gripper 144 to orient the last-sawed (backside) face 140′ of the last shingle 140 to face upward as illustrated in FIG. 19. From this position, the shingles 140, are lowered onto a transfer conveyor 150, for visual inspection.

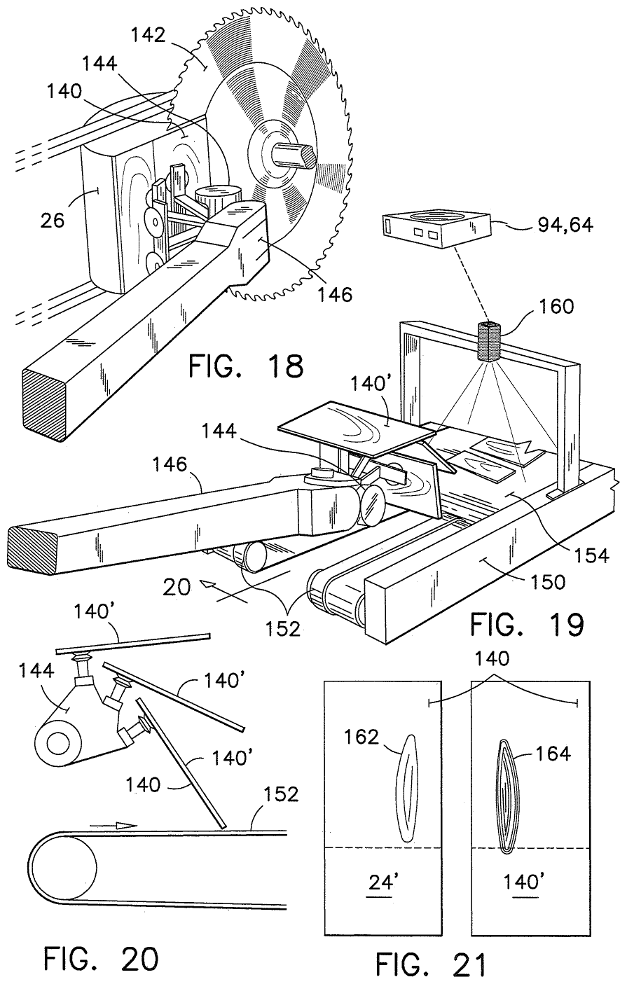

The shingles retained by the gripper 144 are released one at the time on the transfer conveyor 150 in motion with the backside face 140′ of each shingle facing upward. One example to accomplish this is to deposit each shingle onto a moving belt 154, or a combination of spaced-apart narrow moving belts 152, wherein the friction of the belts causes the shingles to lay down on the conveyor 150 with their backside 140′ facing upward. The movement of the belts 152, 154 is synchronized with a rotation and release of the gripper 144 to achieve a smooth deposition of each shingle on the belts 152, 154 as may be understood when looking at FIGS. 19 and 20.

Downstream from the shingle deposit region, the conveyor 150 has a camera 160 installed thereon. The camera 160 is oriented to take primarily, an image of the backside 140′ of each shingle passing there-under on the conveyor belts 152, 154. When the camera finds an unacceptable defect on any of these four faces, that shingle is routed to the “rework” station. The camera 160 is in communication with the machine's computer 94 and algorithm 64, to analyse the backside of each shingle, and to match the backside image with its respective front-face image taken previously. This front-face image is sometimes referred to herein as the woodblock or wood-slab image 24′ and the last-sawed face image is referred to as the backside image 140′.

In a first function of the backside image 140′, this image confirms the decision of a grade determination by the first camera, and the decision by the first camera to initiate a skip-a-scan mode or a double-cut mode.

Referring to FIG. 21, a front-face image 24′ is illustrated alongside its matching backside image 140′. As can be appreciated, a defect 162 on the front-face image 24′, is not always identical to the defect 164 on the backside image 140′. For example, the defect 162 on the front-face image 24′ is a solid discolouration, whereas the defect 164 on the backside 140′ of the same shingle contains some decay.

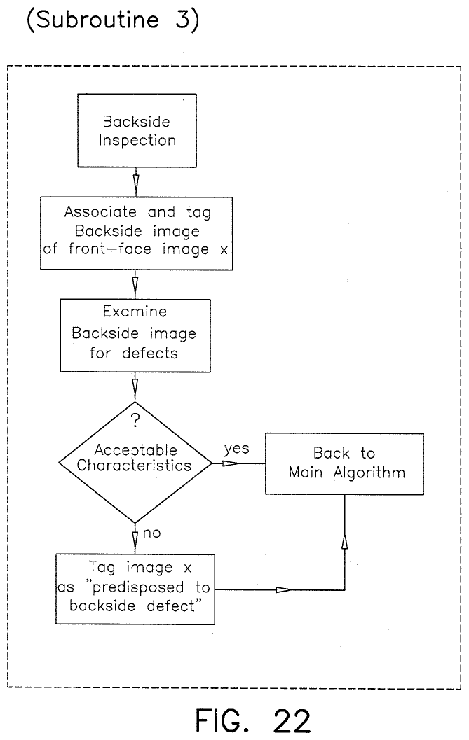

When the backside 140′ of this shingle is matched with its front-face image 24′, and stored in the database of wood defects, the front-face image 24′ is tagged as “susceptible of backside defects” or “predisposed to backside defect” as explained in FIG. 22 in the Subroutine 3, of the preferred algorithm 64. This tagging is advantageous to command a termination of a double cut mode for example, and for preventing the production of a utility or cull shingle. This tagging is also advantageous to prevent a similar predictive-cut decision in the future when a new image is found to match this front-face image. This tagging of “predisposed to backside defect” is comparable to a preview approach where the quality of a next shingle is seen as a mirror image thereof. This tagging improves the quality of the wood defect database and improves overall quality shingle recovery.

### Five-Face Inspection

Using the pair of backside and front-face images it is possible to inspect all five faces of every shingle. The inspection of the core region between the plane of the front-face and the plane of the backside is done with the assumption that a defect in this core region does not appear in isolation in the core region. Core-type defects in the core region of wood shingles, are known to spread to the edge line of one of the backside plane or front-face plane of the shingle and are visible on one of the backside and front-face images. The defect detection algorithm 64 and associated AI are trained to examine the edge lines of every image taken by both cameras 92, 160. When a slight defect is found along one of the edge lines of the backside or front-face image, that defect is treated as a core defect. When no defect is detected along these edges, the shingle is considered as having been inspected on five faces.

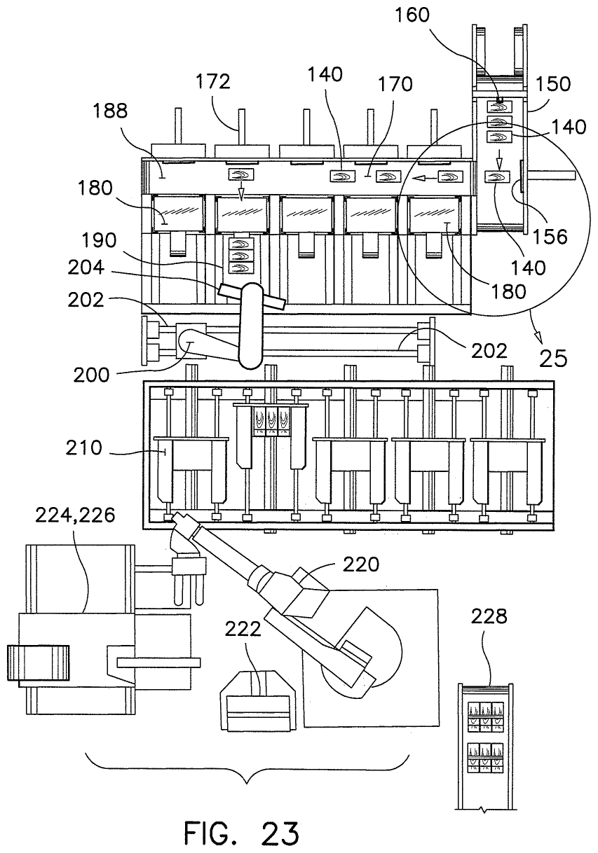

Referring now to FIGS. 23-25, the packaging of shingles will be explained. Firstly, it is important to mention that every shingle carries its own identity, such as grade, width, thickness, orientation, time of production and machine number. Every shingle is also traceable through the inspection and packaging system.

After the backside image of a shingle has been taken and associated with its front-face image, that shingle is carried on the transfer conveyor 150 to a transfer mechanism 156 by which this shingle is diverted onto a sorting conveyor 170. This sorting conveyor 170 runs alongside a series of magazines 180. Additional transfer mechanisms 172, move shingles into one of these magazines 180, according to their respective grades. Five magazines are provided to store shingles of “Grade A”, “B”, “C”, “Utility”, and “Rework”. Each transfer mechanisms 156 and 172 consists of a mechanical device such as a gate, a scraper, a pair of finger-in-groove actuator operated mechanically, pneumatically, or hydraulically. These transfer mechanisms are not illustrated in detail because they are not the focus of the present invention.

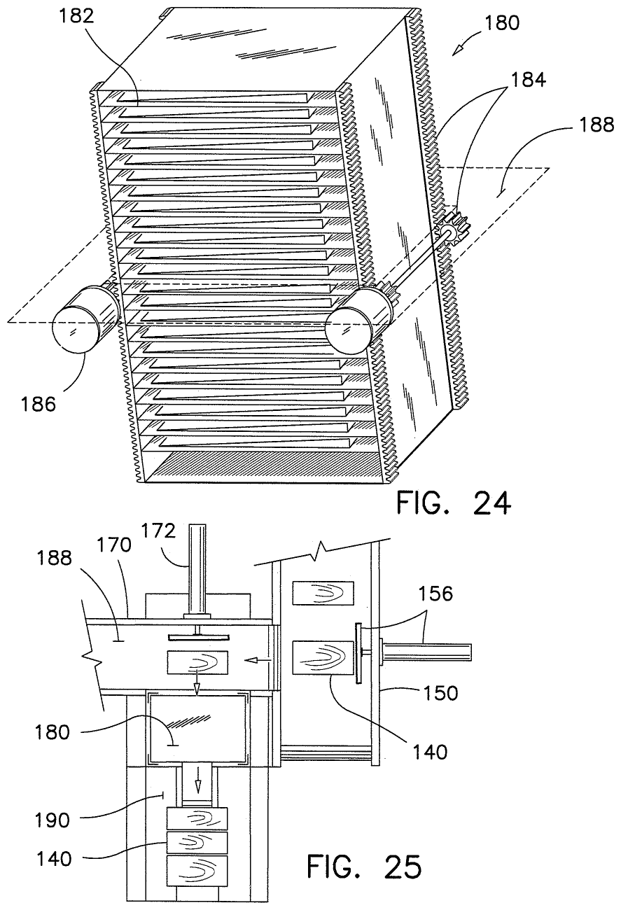

One of the magazines 180 is illustrated in FIG. 24. Each magazine contains at least thirty (30) slots 182. Preferably, this magazine 180 has an indexing mechanism 184 operated by stepper motor(s) 186 for example, to index each slot 182 to the plane 188 of the surface of the sorting conveyor 170. Again, the magazines 180 and the indexing mechanism 184 are illustrated schematically, because these elements are not the focus of the invention. Other magazines and actuators can be used to perform the same function.

It will be appreciated that the shingle in every slot has a known width and orientation. The algorithms mentioned before has a portion thereof dedicated to forming layers of a shingle package. For example, a top and bottom layer of a package contains no more than three shingles, and each layer in between has their juxtaposed edges placed intermediately from one layer to the next. When one magazine 180 has enough shingles to form one layer, transfer mechanism 172 or another transfer mechanism, moves shingles out of the magazine 180, one shingle at the time side by side onto a layer-forming table 190. One layer-forming table 190 is associated with each one of the five magazines 180.

A second robotic picker 200 in FIG. 23, is mounted next to the layer-forming tables 190. This robotic picker 200 is mounted on rails 202 and can move itself to operate over each one of the layer-forming tables 190. This second robotic picker 200 has an elongated picking head 204 that can be rotated 360° in the horizontal plane. The second robotic picker 200 has a configuration capable of selecting one shingle in a layer of shingles on the layer-forming table 190 and rotate that shingle 1800 in the horizontal plane and place it back in the formed layer. This feature is provided to ensure that all shingles in a same layer have the same orientation.

The second purpose of this second robotic picker 200 is to grab and retain a layer of shingle from the layer-forming table 190 and to move this layer into a corresponding package-forming cradle 210. It will be understood that five package-forming cradles 210 are provided to maintain the formation of individual shingle package by grade. The movement of the second robotic picker 200 on rail is convenient to accommodate the transfer of layers from the layer-forming tables 190 to their corresponding cradles 210.

A third robotic picker 220 is mounted alongside the bundle forming cradles 210. This third robotic picker 220 has a configuration and capability to pick wood stickers from a sticker dispenser 222 and to place these stickers on top and bottom of a shingle package being formed in a cradle 210. This third robotic picker 220 also has the configuration and capability to pick a label from a label dispenser 224, and to place that label on a formed shingle package. Furthermore, the third robotic picker 220 has the configuration and capability to transport a shingle package from one of the five cradles 210 to a strapping machine 226 for strapping, and then to place a strapped package onto a warehousing conveyor 228 for moving that package to storage.

It will be appreciated that the sorting and packaging system described herein is very dependent on the squareness of each shingle. Because of the edging and squaring of shingles are done by computer-assisted sawing, the manipulation and transport of shingles along conveyors travelling in orthogonal directions is made possible. The squareness of every shingle prevents a shingle from touching a conveyor surface one edge or one corner before the other and deviating from an ideal alignment on the conveyor surface. Because of the squareness of each shingle, the shingles maintain a true squareness relative to the longitudinal alignment of each conveyor, and of each transfer mechanism.

The shingle packages labelled as “rework” are send back to a manual edging station where edging and repackaging are done in a conventional manner.

The shingles manufactured by the present method are inspected on their front-faces as well as their backsides, their edge faces, and their butt face, to detect surface defects and core defects, thereby ensuring a level of quality never seen before. And, as mentioned before, the shingles in each bundle are traceable to a particular sawing machine and time of manufacturing. The total coverage of each bundle is defined with precision by a computer and algorithm and is more precise than a conventional rule-of-thumb estimation. This information is contained on the label attached to each package, adding another level of quality.

While one embodiment of the post-sawing quality control and packaging system in computer-assisted wood shingle manufacturing operation, has been illustrated in the accompanying drawings and described herein above, it will be appreciated by those skilled in the art that various modifications, alternate constructions, and equivalents may be employed. Therefore, the present disclosure should not be construed as limiting the scope of the invention.

What is claimed is:

1. A system for picking sawed shingles against a saw in movement; said system comprising:
a shingle sawing machine having a carriage and a saw mounted along said carriage;
an electronic group comprising a computer; a machine vision system connected to said computer, an image tracking system for tracking an image taken by said machine vision system, and a carriage tracking system for tracking a movement of a wood block on said carriage toward and away from said saw;
said shingle sawing machine being partly controlled by said electronic group; and
a shingle picker mounted at a proximity of said saw, on a common structure with said saw;
said shingle picker being controlled by said electronic group for guiding said picker to grab a shingle against said saw in movement before said shingle is sawed off said wood block by said saw.

2. The system as claimed in claim 1 further comprising a camera mounted at a proximity of said saw and said shingle picker being configured for rotating a latter-sawed face of said shingle from a plane of said saw to an orientation where said latter-sawed side of said shingle is visible by said camera.

3. A method for maintaining a database of images of shingle defects, comprising the steps of;
taking a front-face image and a backside image of a shingle;
storing said front-face image and said backside image in said database; and
associating said backside image with said front-face image in said database.

4. The method as claimed in claim 3, further comprising the step of; training AI to compare said front-face images and said backside images with images of shingle defects in said database.

5. The method as claimed in claim 4, further comprising the step of tagging said front-face image as “predisposed to backside defect” when said backside image contains an unacceptable defect.

6. The method as claimed in claim 5, further comprising the step of comparing first pairs of adjacent front-face images in said database with second pairs of associated backside images and front-face images in said database and when said first pair matches said second pair, tagging said front-face images from said first pair as “predisposed to backside defect”.

7. The method as claimed in claim 6, further comprising the step of: entering said backside images and said front-face image in said database chronologically and assuming that a last entered backside image is a mirror image of a next shingle to be sawed.

8. The method as claimed in claim 7, further comprising the step of: assuming that a last entered backside image is a preview of a next shingle to be sawed.

9. The method as claimed in claim 8, wherein said preview of a next shingle is a third shingle in a multi-cut mode.

10. A method of manufacturing quality shingle packages comprising the steps of inspecting each shingle in said packages for defect on a front-face, a backside face, a butt face and both edge faces thereof.

11. The method as claimed in claim 10, further comprising the steps of
comparing images of said front-face and said backside with images of wood defects in a database of images of wood defects;
when said image of said front-face matches an image of an acceptable defect and said front-face image is tagged as “predisposed to backside defect”, edging said shingle to remove said acceptable defect.

12. The method as claimed in claim 10, further comprising the step of;
squaring each of said shingles before said shingles are sawed off from a wood block.

13. A method of manufacturing quality shingle packages as claimed in claim 12, further comprising the steps of;
transporting said shingles on a conveyor and storing said shingles individually in a magazine while memorizing a grade, width, orientation and location of each of said shingles;
selecting and feeding said shingles out of said magazine according to a requirement for forming a shingle-bundle layer of known grade, orientation, and dimensions.

14. The method as claimed in claim 12, further comprising the step of;
forming a top and a bottom of said layers in each of said packages with no more than three shingles laid side by side in each of said top and bottom layers.

15. The method as claimed in claim 13, further comprising the step of;
forming shingle-bundle layers with immediately superimposed layers having shingle edges placed intermediately from one of said superimposed layers to a next layer.
